(19) United States
(12) Patent Application Publication
(10) Pub. No.: US 2006/0213312 A1
(43) Pub. Date: Sep. 28, 2006

(54) Shifting arm

(75) Inventors: Stephan Seuferling, Hochstadt (DE); Horst Doppling, Herzogenaurach (DE); Stefan Werner, Neustadt (DE); Rainer Schubel, Aurach (DE)

Correspondence Address: OSTROLENK FABER GERB & SOFFEN, 1180 AVENUE OF THE AMERICAS, NEW YORK, NY, 100368403, US

(73) Assignee: INA-SCHAEFFLER KG

(21) Appl. No.: 11/441,637

(22) Filed: May 26, 2006

Related U.S. Application Data
(63) Continuation of application No. 10/818,247, filed on Apr. 5, 2004, now abandoned.
Application No. 10/818,247 is a continuation of application No. PCT/EP02/10915, filed on Sep. 28, 2002.

(30) Foreign Application Priority Data
Oct. 4, 2001 (DE) 101 48 980.3

(51) Int. Cl. G05G 1/04

(52) U.S. Cl. 74/519

(57) ABSTRACT

A shifting arm for transmitting shifting movements is a formed part which is formed without cutting from a thin sheet. It includes a mouth recess in from an edge of the sheet, and stop faces are formed along the edges of the recess and out of the plane of the sheet.

### CROSS REFERENCE TO RELATED APPLICATIONS

The present application is a continuation of U.S. patent application Ser. No. 10/818,247, filed Apr. 5, 2004, which is a continuation of International Application PCT/EP02/10915, filed Sep. 28, 2002, which claims priority of German Application No. 101 48 980.3, filed Oct. 4, 2001, the entire contents of which are incorporated herein by reference.

### FIELD OF THE INVENTION

The invention relates to a sheet-metal shifting arm for transmitting shifting movements.

### BACKGROUND OF THE INVENTION

Shifting arms of this type are arranged fixedly on shifting elements, such as shifting shafts or shifting forks. The shifting shafts sit displaceably and/or pivotably in the transmission. The shifting forks sit, for example, displaceably and/or pivotably on a shifting rail. The shifting elements are displaced and/or pivoted by means of a shifting finger or an actuating element of similar design. The actuating element engages in a shifting mouth or cutout of similar design on the shifting arm and transmits shifting movements to the shifting element. Locking cylinders or the like also frequently engage in the shifting mouth and prevent gear-shifting errors.

The forces acting on the shifting arm by means of the shifting movements are very high, in particular in the case of shifting errors. In the past, shifting arms of the prior art have therefore been produced predominantly from metal plate or strip material. Thick starting material was also required in order to make the stop faces, which are formed in the shifting mouth and are intended for the shifting fingers, large enough.

The shifting arms are, as a rule, punched parts. The stop faces for the shifting fingers lie, as a rule, opposite each other in the shifting mouth of a shifting arm. Their distance from each other and alignment with respect to each other have to be realized with very high accuracy. Similarly, very exacting requirements are placed on the dimensional accuracy of other, further functional faces in the shifting mouth, for example functional faces for the engagement of a locking cylinder. The required accuracies for the functional dimensions, such as for the distance between the stop faces lying opposite each other in the shifting mouth, and functional faces, such as for the chamfers, which bound the shifting mouth and are required for the gentle introduction of the shifting finger into the shifting mouth, and roundings on body edges, can, as a rule, only be obtained by a material-removing finishing operation. Some functional faces are too rough for a frictional contact with the shifting finger due to the punching outline along the cut edge of the parts after punching has taken place, and therefore also have to be finished with a material-removing operation.

The use of material for the production of the shifting arms is relatively high. The shifting arms are relatively heavy on account of their solid construction and limits are placed on their design due to the material thickness of the starting material. For the above-mentioned reasons, the production of the shifting arms is very cost-intensive particularly in large-series and mass production.

FR 27 62 659 shows a shifting arm of the generic type. A shifting arm produced from metal plate is fastened to a shifting fork. This shifting arm has a shifting mouth. The wall of the shifting arm is reinforced in the region of the shifting mouth in order to provide stop faces of sufficient width.

### SUMMARY OF THE INVENTION

It is therefore the object of the invention to provide a shifting arm which does not have the above-mentioned disadvantages.

This object is achieved according to the invention by the shifting arm being a formed part which is formed from a thin sheet without cutting the sheet. The advantages of a shifting arm according to the invention in comparison with the prior art reside in the low costs for production, particularly in large-series and mass production. The consumption of material for the production of a shifting arm of this type is low. The weight of this shifting arm is reduced by up to 50% in comparison with the shifting arms described at the beginning. The thin material permits virtually unlimited designs. Use is made of forming processes without cutting, in particular processes for the cold-forming of sheets, such as rolling, drawing, stamping and punching. The required accuracies for functional dimensions, such as for the distance of the stop faces lying opposite each other in the shifting mouth, and functional faces, such as for the positioning and dimensioning of chamfers and roundings for the gentle introduction of the shifting finger in the shifting mouth, is, as a rule, obtainable only by the forming process or forming processes. Material-removing machining is unnecessary, as a rule.

Sheets having a thickness of the starting material of up to 2 mm in limit cases of up to 2.5 mm, are preferably used for the production of the shifting arms according to the invention. Sheets of St35, Ck45, C35 and low-alloy deep-drawing steels, such as 16MnCr5, and all weldable and further formable steels and deep-drawing steels can be used as the material. In the selection of the material, account also has to be taken, in accordance with the different applications, of its welding suitability together with the hardening requirements. The shifting arms are preferably fastened by welding to shifting elements, such as shifting rods and shifting forks. The stop faces, in particular, have a hard surface. For this purpose, the shifting arms according to the invention are subjected to edge-layer hardening in the region of the shifting mouth by means of induction hardening processes. It is also conceivable, for cost reasons, to harden the entire shifting arm or the shifting arm welded to the shifting element as one unit. In this case, case-hardening processes or through-hardening processes can be used, depending in each case on the type of steel used.

The object of the invention is furthermore achieved by the shifting arm being a formed part which is formed from a thin sheet without cutting and has a recess open in the shape of a mouth toward one edge of the shifting arm, for the engagement of a shifting finger. The recess is used to provide the shifting mouth on the shifting arm for the engagement of the shifting finger. The shifting mouth is provided, for example, by a cutting-out step in a multi-stage forming process or by punching followed by stamping or protrusion of the edges of the shifting mouth.

In a further refinement of the invention, stop faces for the switching finger are provided with the edges of the recess being protruded or by them being stamped. The sheet at the edges of the recess is preferably protruded in such a manner that the sheet is angled from or out of the plane of the actual flat base body of the shifting arm, generally at right angles, but also at any other desired angle, and as far as possible forms an edge hemming the entire recess. The width of the edge is determined by the required width of the stop faces, which are subsequently stamped onto the edge or produced by means of sizing, and/or also as a function of the demands placed on the stiffness of the shifting arm.

The stop faces for the shifting finger lie, as a rule, opposite each other in the shifting mouth. Their distance from each other and alignment with respect to each other have to be realized with very high accuracy. Similarly, very exacting demands are placed on the dimensional accuracy of other functional faces in the shifting mouth, for example functional faces to rest a locking cylinder against. These accuracies for the functional dimensions, such as for the distance of the stop faces lying opposite each other in the shifting mouth from each other and their alignment with respect to each other, can be ensured, as a rule, without a material-removing finishing operation. Provision is therefore made by one refinement of the invention for the recess to be bounded at least by two stop faces, which lie plane-parallel opposite each other, face each other and are formed without cutting, on angled sections of the sheet, the distance between the stop faces lying opposite each other being realized, by machining without cutting, with an accuracy which permits a deviation from the desired value of the distance of at maximum 1/10 mm. Functional faces, such as the stop faces and such as the chamfers, which bound the shifting mouth or the stop faces and are required for the gentle introduction of the shifting finger into the shifting mouth, and roundings on body edges, are introduced without cutting. The surface of these functional faces is smooth and work-hardened on account of the stampings or the sizing. The resistance to wear of the faces is increased. Material-removing polishing is unnecessary.

A further refinement of the invention makes provision for the recess to be bounded at least by two stop faces, which lie opposite each other, face each other and are formed without cutting, on angled sections of the sheet. In this case, the shifting arm has at least one body edge which delimits the stop face at least at one side to form a further lateral face of the shifting arm and has a chamfer formed on it without cutting. A distance describing the chamfer in the cross section of the shifting arm between an edge, which bounds the stop face towards the chamfer, and an imaginary cut edge has an accuracy which permits a deviation from the desired value of the distance of at maximum 1/10 mm. The imaginary cut edge is a common cut edge, which is parallel to the edge, of the stop face, which is extended beyond the chamfer, together with the further lateral face of the shifting arm, which face is extended beyond the chamfer. The distance of the edge, which separates the stop face from the face produced by the chamfer, from the corner point of an imaginary, unbroken body edge is therefore very precise and can be realized more precisely than the distance brought about by material-removing machining.

The object is furthermore achieved by the shifting arm being a formed part which is formed without cutting from a thin sheet, the formed part being designed in a fork-shaped manner at one end and in this case being provided at the end with two prong-shaped projections. The shifting arm also has at least one edge on its outer contour that is formed by an angled sheet. Each of the projections is provided, on a section which is angled from the sheet of the shifting arm, at least with a stop face which lies opposite a further stop face lying opposite on the other of the projections. A shifting arm of this type can be produced with a great saving on material and has a low weight. The design possibilities are diverse.

With one refinement of the invention, provision is made for the shifting arm to have at least one tab which is angled from the shifting arm, and for the shifting arm to be connected to a shifting element by means of at least one weld on the tab. The tab is fastened to the shifting element by suitable welding processes, such as laser welding, resistance welding or inert-gas arc welding.

In one refinement of the invention, the shifting arm is provided with at least one formation of bead-like design. To prevent the shifting arm from buckling and to increase the torsional rigidity, the shifting arm is provided on the different wall sections in a manner corresponding to its purpose with one or more beads or with laminations, stampings, protrusions of the sheet or bending over of the sheet at the edges, which are produced without cutting. Also very effective in this respect is an edge which is peripherally reinforced as far as possible on the shifting arm, which is essentially of flat design. This reinforced edge is produced by a bead or by a sheet which is angled away at the edge from the flat base body.

The invention makes provision, in particular for higher loads, for the shifting arm to be a bracket-shaped formed part which is formed without cutting from a thin sheet. In this case, the shifting arm has a first wall section with a recess open in the shape of a mouth toward one edge of the shifting arm, for the engagement of a shifting finger. The recess is bounded at least by two sections, which lie opposite each other and face each other and are formed without cutting, on angled sections of the sheet. The first wall section merges integrally into three further wall sections which are angled from the first wall section and facing the same direction. A refinement of the invention makes further provision in this respect for the further three wall sections of the shifting arm also to be formed integrally with one another. The shifting arm is therefore formed by a deep-drawn part of shell-shaped design. With another refinement, provision is made for those wall sections of the shifting arm which are drawn to each other in a flat sheet-metal blank to be bent off from the flat blank, brought together and welded at the contact points in such a manner that the sheet-metal part obtains a shell- or bracket-shaped form.

Finally, provision is made with one refinement of the invention for the shifting arm to have at least one formation of bead-like design on at least one of the wall sections. To prevent the shifting arm from buckling and to increase the torsional rigidity, the shifting arm is provided on at least one or individual or all of the different wall sections in accordance with its use with one or more beads or with laminations, stampings, protrusions of the sheet or bending over of the sheet at the edges, which are produced without cutting.

Other features and advantages of the present invention will become apparent from the following description of the invention which refers to the accompanying drawings.

### BRIEF DESCRIPTION OF THE DRAWINGS

The invention is explained in greater detail below with reference to a number of exemplary embodiments, in which:

FIG. 1 shows an exemplary embodiment of a shifting arm according to the invention in a perspective view,

FIG. 2 shows the shifting arm from FIG. 1 in the view from the front,

FIG. 3 shows the shifting arm from FIG. 1 in a side view sectioned along the line III-III according to FIG. 2,

FIG. 4 shows a partial view of the shifting arm according to FIG. 1 in a sectional illustration along the line IV-IV according to FIG. 2,

FIG. 5 shows an exemplary embodiment of a shifting arm according to the invention which is of bracket-shaped design,

FIG. 6 shows the shifting arm from FIG. 5 in the view from the front,

FIG. 7 shows the shifting arm from FIG. 5 in a side view sectioned along the line VII-VII according to FIG. 6,

FIG. 8 shows a further exemplary embodiment of a shifting arm according to the invention in its initial state before the wall sections are brought together,

FIG. 9 shows the finished shifting arm according to FIG. 8 in the view from the front,

FIG. 10 shows the shifting arm according to FIG. 9 in a side view, illustrated in section,

FIG. 11 shows a further exemplary embodiment of a shifting arm of flat design,

FIG. 12 shows the shifting arm from FIG. 10, fastened to a shifting element, and

FIG. 13 shows the shifting arm from FIG. 1, fastened to a shifting element.

### DETAILED DESCRIPTION OF PREFERRED EMBODIMENTS OF THE INVENTION

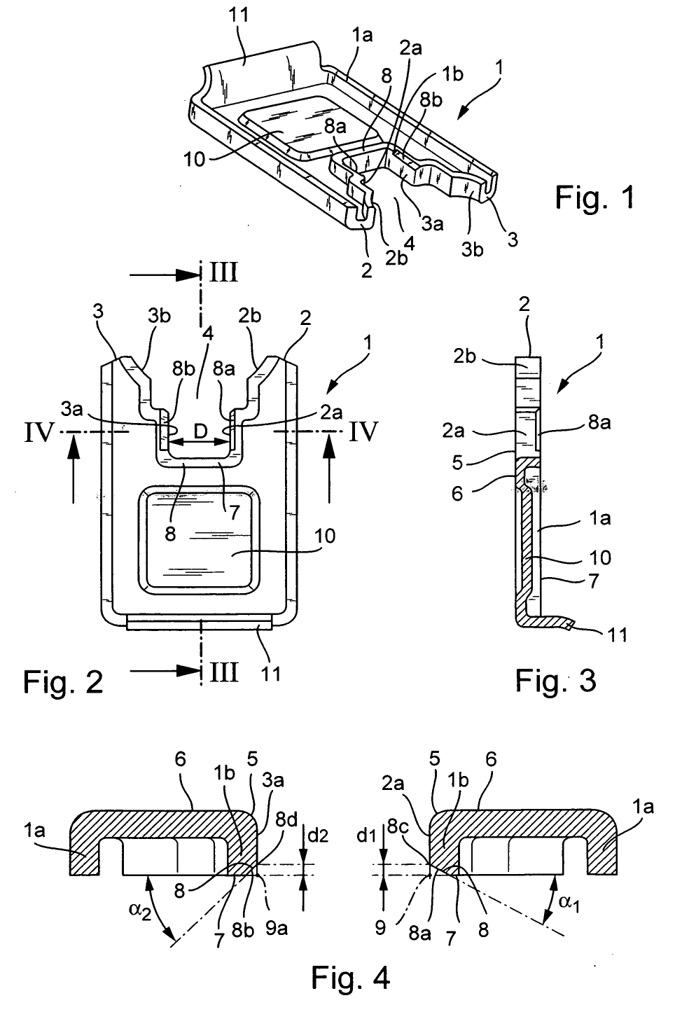

FIGS. 1 to 4 illustrate a shifting arm. The shifting arm 1 is formed from a flat formed part which is formed without cutting from a thin sheet of 2 mm. The formed part has a fork-shaped design and has two prong-shaped projections 2 and 3. The projections 2 and 3 bound a recess 4. The recess 4 is partially bounded by four stop faces 2a, 2b, 3a, 3b lying opposite one another. A shifting finger (not illustrated) strikes against the stop faces 2a and 3a. The stop faces 2b and 3b, which are designed lying opposite each other, are, in a locking position, a stop for a locking cylinder or locking pin (not illustrated). Each of the stop faces 2a, 2b, 3a, 3b is formed on a section 1b which hems the recess 4 and is angled away from meaning out of the plane of the sheet or the plane of the shifting arm 1 or of the projections 2 and 3. The stop faces 2a and 3a face each other and are aligned plane-parallel to each other. The clear distance D between the stop faces 2a and 3a is realized, by forming without cutting, with an accuracy which permits a deviation from the desired value of the distance of at maximum 1/10 mm.

A body edge 5 which bounds the contour of the recess 4 on one side delimits the stop faces 2a, 2b, 3a, 3b (FIG. 4) with respect to a rear lateral face 6 of the shifting arm. At the height of the stop faces 2a and 3a, the body edge 5 is rounded by the forming process. The rounding has a radius which is smaller than the wall thickness of the shifting arm 1 in the region of the stop faces 2a and 3a. The stop faces 2a and 3a are delimited by a further body edge 8 with respect to the other flat side of the shifting arm 1, which side lies opposite the rear lateral face 6 and therefore the body edge 5 and has the front lateral face 7. This body edge 8 has a chamfer 8a at least at the height of the stop face 2a and a chamfer 8b at the height of the stop surface 3a. The distance d₁ describing the chamfer 8a in cross section (FIG. 4) together with the angle α₁ from the edge 8c to an imaginary, common cut edge 9, which is aligned parallel to the edge 8c, is realized with an accuracy which permits a deviation of the desired value of at maximum 1/10 mm. The edge 8c delimits the stop face 2a with respect to the chamfer 8a. The cut edge 9 is a cut edge which would form an imaginary body edge not broken by a chamfer, between the stop face 2a and the front lateral face 7. The distance d₂ describing the chamfer 8b in the cross section (FIG. 4) together with the angle α₂ from the edge 8d to an imaginary, common cut edge 9a, which is aligned parallel to the edge 8d, is, in the same manner as the distance d₁, realized with an accuracy which permits a deviation of the desired value of at maximum 1/10 mm. In this case, the edge 8d is an edge bounding the stop face 3a with respect to the chamfer 8b. The cut edge 9a is a cut edge which is aligned parallel to the edge 8d and would form an imaginary body edge which was not broken by a chamfer, between the stop face 3a and the front lateral face 7.

The contour of the shifting arm 1 is reinforced against impermissible deformations under load by means of an edge 1a which is formed from an angled sheet of the shifting arm 1. Furthermore, the shifting arm 1 has a formation 10 which is of bead-like design and likewise leads to a high rigidity of the sheet-metal part.

A tab 11 leads off from the shifting arm 1 and is provided for fastening the shifting arm to a shifting element, which is moveable with respect to its longitudinal center axis. FIG. 13 illustrates, for example, the manner in which the shifting arm 1 is fastened to the guide eye 12a of a shifting fork 12 by means of the tab 11. The tab 11 is bent in a rounded manner matching the shape of the guide eye 12a and, bearing against the guide eye 12a, is welded to the guide eye 12a.

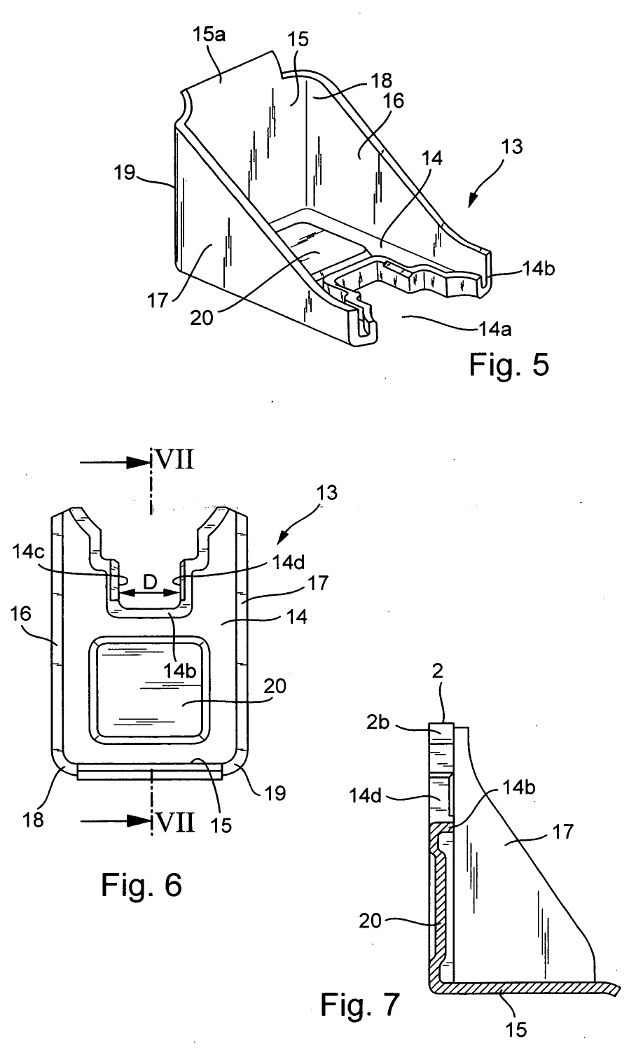

A further exemplary embodiment of the invention is illustrated in FIG. 5 to FIG. 7. A shifting arm 13 is a formed part of thin sheet having a bracket-shaped design. The shifting arm 13 is formed from a first wall section 14 and three further wall sections 15, 16 and 17. The three wall sections 15, 16 and 17, which are formed integrally with the first wall section 14, lead off from the first wall section 14 at right angles and facing in the same direction and are also connected integrally to one another at the corners 18 and 19. The wall section 15 functions as a supporting plate of the shifting arm 13, on which the first wall section 14 is supported, when subjected to a load exerted, for example, by shifting fingers (not illustrated) via the wall sections 16 and 17 functioning as asset plates. A tab 15a protruding out of the wall section 15 is provided for securing the shifting arm 13 on a shifting element (not illustrated), for example a shifting fork or a shifting shaft. The first wall section 14 has a formation 20 which is of bead-like design and, like the wall sections 16 and 17, results in a high rigidity of the sheet-metal part.

The first wall section 14 is provided with a mouth-shaped recess 14a which is open toward the free edge of the wall section 14. The recess 14a is hemmed on its peripheral edge 14b by a sheet which is angled away from the flat wall section 14. Stop faces 14c and 14d are formed, in each case without cutting, in the sheet of the edge 14a. The stop faces 14c and 14d lie opposite each other on the recess 14a and are aligned parallel to each other. The distance D between the stop faces 14c and 14d is realized by cold-forming of the sheet with an accuracy which permits a deviation of the distance D from its desired value of at maximum 1/10 mm.

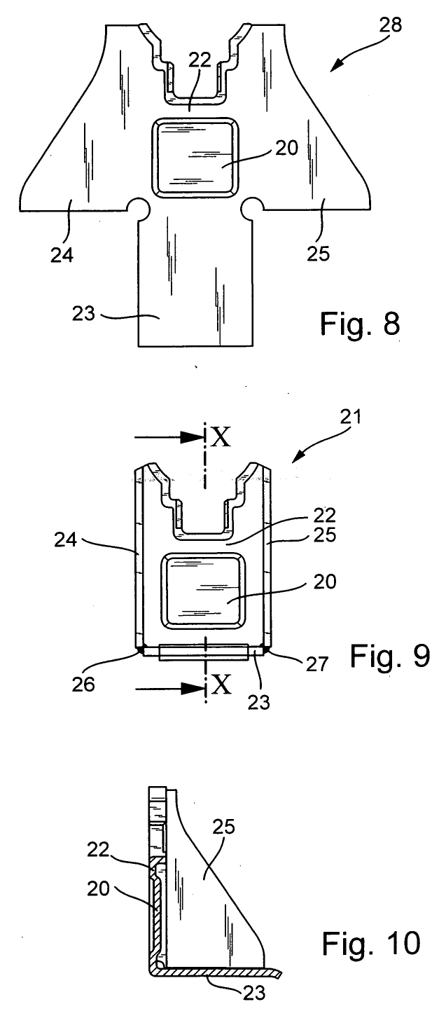

FIGS. 9 and 10 show an alternative design of a shifting arm 21 from the shifting arm according to FIG. 5. The shifting arm 21 is formed from a first wall section 22 and three further wall sections 23, 24 and 25. FIG. 8 shows the unfinished shifting arm 21 in the form of a blank 28 which is partially formed at the shifting mouth. The wall sections 23, 24 and 25, which are stretched out flat in the plane of the wall section 22 on this blank 28, are connected integrally to the wall section 22. On the finished shifting arm 21 (FIG. 9 and FIG. 10) the wall sections 23, 24 and 25 are bent off from the first wall section 22 at right angles and facing in the same direction. The wall sections 23 and 24 and 23 and 25 are respectively brought together and welded together at the corners 26 and 27.

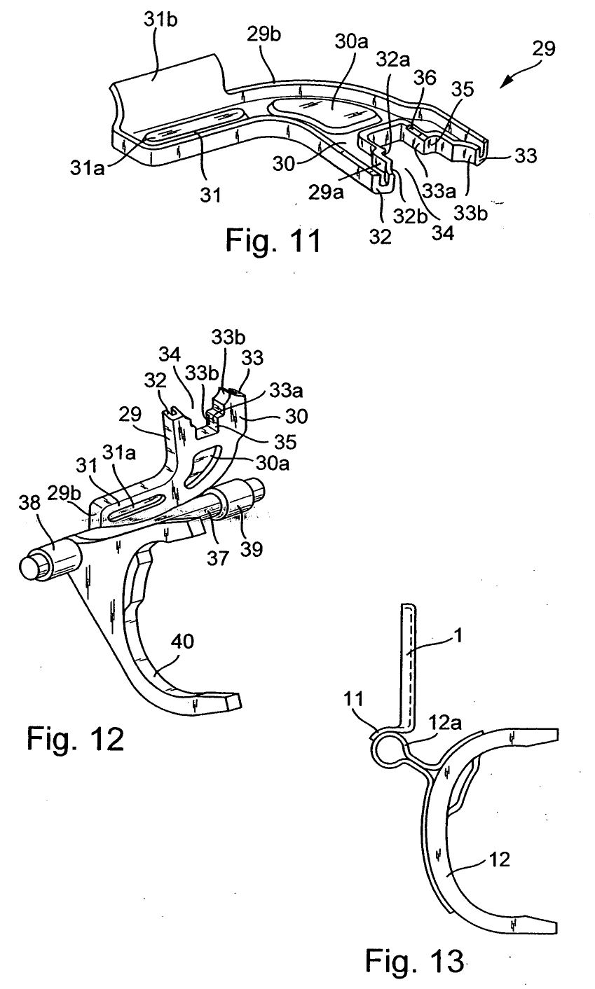

FIGS. 11 and 12 show a shifting arm 29. The shifting arm 29 is a formed part of essentially flat design and of thin sheet. The shifting arm 29 is designed such that it is angled in its main plane running into two limbs 30 and 31. The limb 30 is designed in a fork-shaped manner at its free end and has two prong-shaped projections 32 and 33. The projections 32 and 33 bound a recess 34. The recess 34 is partially bounded by four stop faces 32a, 32b, 33a, 33b lying opposite one another, for a shifting finger (not illustrated). The stop faces 32b and 33b, which are formed lying opposite each other, are, in a locking position, a stop for a locking cylinder or locking pin (not illustrated). Each of the stop faces 32a, 32b, 33a, 33b is formed on a section 29a which hems the recess 34 and is angled away from the sheet of the shifting arm 29. The stop faces 32a and 33a face each other and their surface is shaped in a manner such that it is slightly outwardly curved into the recess 34 from the body edges 35 and 36 to the center of the particular stop face 32a and 33a.

The contour of the shifting arm 29 is reinforced against impermissible deformation under load by means of an edge 29b formed from an angled sheet of the shifting arm 29. The shifting arm 29 furthermore has a formation 31a of bead-like design on the limb 31 and a bead-like formation 30a on the limb 30, which formations likewise lead to a high rigidity of the sheet-metal part. A tab 31b leads off from the shifting arm 29 and is provided for fastening the shifting arm 29 to a shifting element, which is moveable with respect to its longitudinal center axis.

FIG. 12 illustrates the manner in which the shifting arm 29 is fastened to a shifting rod 37 by means of the tab 31b, for example. The tab 31b is bent in a rounded manner matching the shape of the cylindrical outer surface area of the shifting rod 37 and, bearing against the shifting rod 37, is welded to the shifting rod 37. A shifting fork 40 is fastened to the shifting rod 37. The shifting rod 37 can be displaced along its longitudinal center axis by means of bearings 38 and 39 and is mounted in a manner such that it can pivot about its longitudinal center axis in a transmission (not illustrated).

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A sheet-metal shifting arm for transmitting shifting movements in a transmission, the shifting arm being formed from a thin sheet without cutting the sheet.

2. The shifting arm as claimed in claim 1, wherein the sheet has a thickness of up to 2 mm in its initial state before the forming of the shifting arm.

3. The shifting arm as claimed in claim 1, wherein the material of the shifting arm is a deep-drawing steel.

4. The shifting arm as claimed in claim 1, wherein the material of the shifting arm is a low-alloy deep-drawing steel.

5. The shifting arm as claimed in claim 1, further including a shifting element welded to the shifting arm, the shifting element being moveable with respect to a longitudinal center axis thereof.

6. The shifting arm as claimed in claim 5, wherein the shifting element is a shifting rod which is displaceable along its longitudinal center axis and is pivotable about its longitudinal center axis.

7. The shifting arm as claimed in claim 5, wherein the shifting element is a shifting fork.

8. A sheet-metal shifting arm for transmitting shifting movements in a transmission, wherein the shifting arm is a formed part which is formed without cutting from a thin sheet, and which has a recess which is open in the shape of a mouth toward one edge of the shifting arm, adapted for engagement of a shifting finger.

9. The shifting arm as claimed in claim 8, wherein the recess is at least partially bounded by two opposed stop faces.

10. The shifting arm as claimed in claim 9, wherein the two stop faces lie in opposed parallel planes and are formed without cutting of the sheet; the sheet having at least one angled section out of the plane of the sheet and the stop faces being formed on the at least one angled section of the sheet.

11. The shifting arm as claimed in claim 10, wherein the recess is bounded at least partially by two stop faces which are machined such that the distance between the opposed stop faces is accurate to a tolerance of ± 1/10 mm.

12. The shifting arm as claimed in claim 8, wherein the recess is at least partially bounded by two opposed stop faces formed without cutting of the sheet; wherein a stop face on at least one side adjoins a body edge of the sheet, the sheet adjoining the body edge where the sheet is rounded without cutting of the sheet.

13. The shifting arm as claimed in claim 10, wherein the shifting arm has at least one body edge which delimits the stop face on at least one side to form a lateral face of the shifting arm, and the body edge has a chamfer that is formed on it without cutting of the sheet.

14. The shifting arm as claimed in claim 8, wherein:
the recess is at least partially bounded by two opposed stop faces, which are formed without cutting;
the sheet has at least one angled section out of the plane of the sheet;
the shifting arm has at least one body edge on the angled section which delimits the stop face on at least one side to form a lateral face of the shifting arm, and the body edge has a chamfer formed on it without cutting of the sheet;
a distance of the chamfer in a cross section of the shifting arm between an edge, which bounds the stop face at a side toward the chamfer, and an imaginary common cut edge which extends parallel to the edge of the stop face and is extended beyond the chamfer, exhibits a tolerance of ± 1/10 mm.

15. A sheet-metal shifting arm for transmitting shifting movements in a transmission, wherein the shifting arm is a flat formed part which is formed from a thin sheet without cutting of the sheet, the formed part having one end in a fork-shape, the one end having two prong-shaped projections and having at least one edge which is formed by an angled section out of the plane of the sheet, each of the projections having a first stop face on the angled section and another opposed stop face on the other of the projections.

16. The shifting arm as claimed in claim 15, wherein the shifting arm has at least one tab leading off from the shifting arm, enabling the shifting arm to be connected to a shifting element by at least one weld on the tab.

17. The shifting arm as claimed in claim 15, wherein the shifting arm includes at least one formation of the sheet that is of bead-shape.

18. A sheet-metal shifting arm for transmitting shifting movements in a transmission, wherein the shifting arm has a bracket-shape and is formed from a thin sheet without cutting of the sheet;
the shifting arm having a first wall section with a recess opening therein in the shape of a mouth opening toward one edge of the shifting arm, and the opening being adapted for engagement of a shifting finger;
the recess being at least partially bounded by two opposed stop faces, which are formed without cutting of the sheet; the sheet having angled sections out of the plane of the sheet in which the stop faces are formed;
the sheet including three further wall sections which are angled out of the plane of the sheet and angled out of the first wall section and which projects in the same direction out of the plane, and the first wall section merging integrally into the three further wall sections.

19. The shifting arm as claimed in claim 18, wherein the three further wall sections are formed integrally with one another.

20. The shifting arm as claimed in claim 18, wherein the three further wall sections are bent off from the first wall section, and the three further wall sections are brought together so that each two of the further wall sections are fastened to each other.

21. The shifting arm as claimed in claim 18, wherein the shifting arm includes at least one formation of the sheet that is of bead design.

22. A process for forming a sheet-metal shifting arm for transmitting shifting movements, said process comprising the steps of:
cold-forming only of sheet metal to obtain necessary accuracies of functional dimensions of said sheet-metal shifting arm; and
hardening at least a portion of said sheet metal,
said process not including a step of cutting said sheet metal.

23. A process as claimed in claim 22, wherein said step of cold-forming of sheet metal includes at least one cold-forming process selected from the group of cold-forming processes consisting of rolling, drawing, stamping, and punching.

24. A process as claimed in claim 22, wherein said step of cold-forming of sheet metal includes the formation of a mouth-shaped opening in said sheet metal.

25. A process as claimed in claim 22, wherein said step of cold-forming of sheet metal includes bending at least a portion of said sheet metal adjacent to at least one edge of said sheet metal.

26. A process as claimed in claim 22, wherein said step of hardening includes one hardening process selected from the group of hardening processes consisting of case-hardening and through-hardening.
